(19) United States
(12) Patent Application Publication
(10) Pub. No.: US 2016/0144460 A1
(43) Pub. Date: May 26, 2016

(54) Materials and Methods for Soldering, and Soldered Products

(71) Applicant: CAMBRIDGE ENTERPRISE LIMITED, Cambridge (GB)

(72) Inventors: Marek Burda, Gliwice (PL); Agnieszka Lekawa-Raus, Naleczow (PL); Krzysztof Kazimierz Koziol, Cambridge (GB); Andrzej Gruszczyk, Orzesze (PL); Jacek Gorka, Sanok (PL)

(21) Appl. No.: 14/903,701

(22) PCT Filed: Jul. 10, 2014
(86) PCT No.: PCT/GB2014/052105

§ 371 Date: Jan. 8, 2016

(30) Foreign Application Priority Data
Jul. 10, 2013 (GB) 1312388.0

(51) Int. Cl. B23K 35/02; H01B 1/02; H01B 1/04; B23K 35/26; C22C 13/02

(52) U.S. Cl. CPC B23K 35/0222; B23K 35/262; C22C 13/02; H01B 1/04; H01B 1/02

(57) ABSTRACT

A tin-based alloy consists essentially of: (i) matrix components comprising two or more of Ag, Cu, Sb, Bi, Pb, In, Zn, Cd, Ga, Au, Ge, Si, P, Al, each matrix component being present in an amount 0.01-6.0 wt %; (ii) a transition metal active component comprising one or more of Cr, Ni, Ti, Co, Fe, Mn, Nb, Mo, Hf, Ta, W, the total amount of all said transition metal active components being more than 1.0 wt % and not more than 10 wt %; (iii) C present in an amount 0.01-1.0 wt %, and (iv) balance Sn and incidental impurities. Preferred compositions include Sn—(Ag, Cu, Sb, Bi, Pb)—(Cr, Ni)—C. The alloy is of use for soldering carbon-based materials such as carbon nanotubes.

### FIELD OF THE INVENTION

The present invention relates to alloys suitable for use in solder compositions, to solder compositions, to use of the alloys in soldering and to methods of soldering. The invention also relates to soldered products. The present invention has particular application in soldering carbon materials, such as, but not exclusively, carbon nanotube materials, to join them for example to each other, to other carbon materials and/or to different materials such as metals.

### BACKGROUND

New generation electrical wiring is expected to be based on carbon nanotube materials [Refs 1-5]. Carbon nanotube wiring systems have the potential to provide extremely high electrical and thermal conductivity combined with superior mechanical strength and low weight [Refs 6-8]. Furthermore, carbon nanotube wires have the advantage of functioning and achieving very high electrical performance at room temperature.

However, the utility of carbon nanotube wiring systems relies on the ability to form mechanically stable, conductive connections between the carbon nanotube wires and other circuit components, such as metal components, and between the carbon nanotube wires themselves. Providing such connections remains a significant problem in the field.

Similar problems may also be encountered when joining other carbon nanotube materials, as well as carbon fibre based materials, graphite, graphene and other carbon-based materials. When joining carbon materials with metals or metal alloys, the final properties at the carbon-metal interface depend on numerous factors, including the thermal stability of the carbon based materials in molten metal, wetting behaviour in the metal-carbon system, and kinetic and thermodynamic aspects of possible carbide nucleation [Refs 9,10]. In the case of materials with a high surface area to volume ratio, such as carbon nanomaterials (e.g. materials comprising carbon nanotubes), the significance of factors influencing behaviour at the metal-carbon interface is markedly increased.

A particular obstacle to successful joining of carbon materials, and particularly carbon nanotube materials, is very poor wetting of the carbon material by molten metal. Wettability of solids by liquids depends on the balance between surface tension of liquid and surface free energy of solid, as illustrated in FIG. 1.

The calculated surface free energy of multiwall carbon nanotubes is typically in the range of 20-45 mJ m⁻², meaning that only liquids with a low surface tension γ_{LV} of about 100-200 mN m⁻¹ will provide reliable wettability of carbon nanotube materials [Ref 13]. Surface tension of a large majority of metals is considerably higher, for example for aluminium it is 840-880 mN m⁻¹, for copper it is 1140-1220 mNm⁻¹, and for iron it is 1325-1505 mN m⁻¹ [Ref 14]. Therefore, fabrication of high quality joints or composites in metal-carbon nanotube systems requires a reduction of the metal surface tension or modification of the carbon nanotube surface. However, modification of the carbon nanotube material surface typically leads to a deterioration of the properties of the material.

Typically, the observed mechanical, electrical and thermal properties of composite metal materials reinforced by carbon nanotubes have been considerably worse than theoretical models predict [Refs 11,12]. This is attributed to ineffective load, charge or heat transfer at the carbon-metal boundary.

Attempts have been made to improve the properties of copper materials reinforced by carbon nanotubes, by first electroplating or electroless plating nickel onto the surface of the carbon nanotubes. As a result of the good mutual solubility of copper and nickel, this improves the effective load transfer ability [Refs 15,16].

A further approach to improving wetting of carbon materials by molten metals is by chemical reaction. Metals which have a large negative Gibbs free energy of carbide formation can improve wetting of carbon materials [Ref 10]. For example, U.S. Pat. No. 4,707,576 describes a process for soldering a carbon fibre reinforced graphite electrode to a metal carrier by covering the graphite electrode with particles of a carbide forming element such as chromium, then applying a high temperature solder. U.S. Pat. No. 3,484,210 and U.S. Pat. No. 3,361,561 describe depositing an alloy of tin and a carbide forming element on a carbon or graphite component, by weld depositing in argon or helium. Weld depositing is an extremely high temperature process. Following the weld depositing, the carbon component is attached to a metal component using conventional solder, such as 50% tin and 50% lead solder.

The existing high temperature processes are unsuitable for use with carbon materials which can be susceptible to thermal degradation, such as carbon nanotubes, since these materials may break down under the conditions employed. There remains a need for materials and processes suitable for joining carbon nanotube materials such as carbon nanotube wires, and more generally for improved methods of joining carbon materials to each other, and to other materials such as metals.

WO 2007/070548 discloses various Sn—Ag—Cu based solder alloys having improved drop impact reliability. The level of addition of various elements to the basic composition is relatively low. Reference 19 discloses the results of investigations into reactions between Cu and Sn2.5Ag0.8Cu doped with 0.03 wt % Fe, Co or Ni. Reference 20 discloses the results of investigations into low level (up to 1 wt %) Ti additions into the properties of Sn3.5Ag0.5Cu. These three documents identify various solder compositions but do not consider their use in soldering of carbon materials.

SU-A-597532 discloses a solder composition Sn, 1-2 wt % Ag, 24 wt % Cu, 1.5-2.5 wt % In, 12-18% Sb, 0.2-0.4% Ti for use in joining nickel-plated siliconised graphite to steel.

U.S. Pat. No. 2007/0228109 discloses a solder composition comprising up to 10 wt % of one or more of Ti, Zr, Hf, V, Nb, Ta, 0.1-5 wt % lanthanides, 0.01-1 wt % Ga, 0.1-2 wt % Mg, up to 10 wt % Ag, the remainder being Sn, Bi, In, Cd or a mixture of two or more of Sn, Bi, In, Cd.

U.S. Pat. No. 3,484,210, mentioned above, contains only a very generic disclosure of suitable compositions for soldering to graphite. The disclosure is simply of an alloy of a first, second and third component. The first component is 0.8-40 parts Ti or 0.667-40 parts V or 1.0-40 parts Zr. The second component is 200 parts Sn. Optionally additional components include one of Cu and Ag.

### SUMMARY OF THE INVENTION

The present inventors have concentrated their efforts on developing alloys for use in soldering of carbon materials, in particular seeking to improve the wettability of carbon materials by the solder alloy whilst allowing a relatively low temperature soldering process, in order that the process can be used to solder materials which are susceptible to damage at high temperature. In this way, the inventors have sought to address the problems mentioned above.

Accordingly, in a first aspect, the present invention provides a tin-based alloy consisting essentially of:
matrix components comprising two or more of Ag, Cu, Sb, Bi, Pb, In, Zn, Cd, Ga, Au, Ge, Si, P, Al, each matrix component being present in an amount 0.01-6.0 wt %;
a transition metal active component comprising one or more of Cr, Ni, Ti, Co, Fe, Mn, Nb, Mo, Hf, Ta, W, the total amount of all said transition metal active components being more than 1.0 wt % and not more than 10 wt %;
optionally C present in an amount 0.01-1.0 wt %, and
balance Sn and incidental impurities.

As demonstrated in the Examples detailed below, such alloys provide a suitable basis for the low-temperature soldering of carbon-based materials, in which suitable wetting of the carbon-based materials is achieved. Without wishing to be bound by theory, it is considered that the inclusion of the transition metal active component at a suitable level in a suitable matrix allows the control of the course of various complex surface processes between the carbon material and the solder alloy, thus allowing control of the wettability of the carbon material and the work of adhesion. This is illustrated schematically in FIG. 2, in which the term “reaction product” is used to indicate the possible zone of chemical interaction between the solder alloy and the carbon material. Furthermore, the properties of the carbon material, e.g. its conductivity, are not significantly degraded by the soldering process, or are not degraded at all. Carbon is optionally included because in some circumstances it is considered to provide advantageous technical effects. For example, inclusion of carbon (e.g. in the form of a carbon material as specified below) can assist in the wetting of a substrate by the alloy. In particular, wetting of stainless steel is found to be improved.

In a second aspect, the present invention provides a solder composition including a tin-based alloy according to the first aspect and flux.

As will be understood by the skilled person, a typical flux suitable for soldering may be composed of: a) rosin or resin based vehicle protecting hot metal against activation, b) activators based on acids used for disrupting or dissolving metal oxides, c) solvents, e.g. ethanol or 2-propanol, d) additives such as surfactants, corrosion inhibitors, stabilizers, etc. As the flux to be used in the second aspect, it is considered that suitable flux can be selected from: 1) resin based fluxes, with or without activators; 2) organic fluxes, with or without activators; and 3) inorganic fluxes based on salts, acids or alkalis.

In a third aspect, the present invention provides a use of a tin-based alloy according to the first aspect as a filler material to solder a carbon material.

In a fourth aspect, the present invention provides a method of soldering a carbon material, the method comprising
heating a tin-based alloy filler to melt it, the tin-based alloy being according to the first aspect, then
solidifying the tin-based alloy filler in contact with the carbon material.

It will be understood that the present invention also provides soldered products which are obtainable by soldering using the alloys/compositions described herein, for example using the soldering methods described herein. Accordingly, in a fifth aspect, the present invention provides a soldered product comprising a first component electrically conductively connected to a second component via solder material,
wherein the first component comprises carbon material, which carbon material is adhered to the solder material
and wherein the solder material comprises a tin-based alloy filler according to the first aspect.

Further preferred or optional features of the invention will now be set out. Any aspect of the invention may be combined with any other aspect, unless the context demands otherwise. Any of the preferred or optional features of any aspect may be combined, either singly or in combination, with any aspect of the invention, unless the context demands otherwise. Where a series of end points for a particular range is given, it is to be understood that any one of those end points can be applied independently to the invention.

As discussed above, the present invention provides alloys and compositions for use in soldering carbon materials, and methods of soldering carbon materials using the alloys and compositions. It will be understood that the nature of the carbon material is not particularly limited. The carbon material may be, for example, graphite, graphene, carbon fibre or a material comprising carbon nanotubes. Other carbon nanomaterials are also suitable such as carbon nanoribbons, carbon nanohorns, carbon nanofibres, herringbone carbon nanostructures, fullerene nanostructures, and magnetic carbons. Also suitable are mixtures of different carbon materials, and composite materials comprising carbon materials. This and the following explanation of “carbon materials” also applies to carbon material that may be included in the alloy composition of the first aspect.

The alloys of the present invention are suitable for use in low temperature soldering methods. As a result, the use of these alloys is particularly suited to materials which are unstable under the process conditions employed in high temperature joining processes of the prior art. For example, the present invention may be particularly applicable to carbon materials comprising carbon nanotubes, and to carbon fibre. Carbon fibre typically has a diameter of about 20 μm or below, about 15 μm or below, or about 10 μm or below. It may have a diameter of at least about 1 μm, or at least about 3 μm, or at least about 5 μm.

A particularly preferred carbon material is a carbon material comprising carbon nanotubes. For example, the carbon material may comprise at least 60% by weight of carbon nanotubes. Preferably, the carbon material comprises at least 75% by weight of carbon nanotubes. It may comprise at least 80%, 85%, 90%, 95%, 96%, 97%, 98% or 99% by weight of carbon nanotubes. In the soldered products of the preferred embodiments, the first and/or second component may be an electrically conductive fibre or yarn comprising carbon nanotubes at any of the weight percentages set out here.

It will be understood that the carbon material comprising carbon nanotubes may comprise other components. For example, residual catalyst particles, such as metallic catalyst particles employed in the synthesis of the carbon nanotubes may remain in the fibre. Accordingly, the fibre may comprise a plurality of catalyst particles dispersed in the fibre. Preferably, the fibre comprises 20% by weight or less of catalyst particles, for example 15%, 10%, 5%, 4%, 3%, 2% or 1% by weight or less of catalyst particles. Non-metallic impurities may also be present.

Metals, such as silver, may be incorporated into the fibre comprising carbon nanotubes. This may enhance the conducting properties of the fibre.

Preferably, the carbon material comprising carbon nanotubes comprises predominantly single walled carbon nanotubes, for example substantially all of the carbon nanotubes may be single walled carbon nanotubes. Alternatively or additionally, the carbon nanotubes may include double-, triple- and multi-walled carbon nanotubes and mixtures thereof. Both collapsed and non-collapsed carbon nanotubes are suitable.

Preferably, the carbon material comprising carbon nanotubes comprises predominantly metallic carbon nanotubes, for example substantially all of the carbon nanotubes may be metallic carbon nanotubes. Preferably, the carbon material comprising carbon nanotubes comprises predominantly armchair carbon nanotubes, for example substantially all of the carbon nanotubes may be armchair carbon nanotubes.

The electrically conducting fibre comprising carbon nanotubes may have structural voids between individual carbon nanotubes. Alternatively, it may be substantially free of voids, and show substantially perfect packing morphology.

In particularly preferred embodiments, the material comprising carbon nanotubes is a fibre, yarn or rope. It will be understood that a carbon nanotube fibre typically comprises a very large number of carbon nanotubes. As used herein, the term “fibre” includes a single fibre or yarn (comprising a large number of carbon nanotubes), and a bundle (e.g. rope or cable) comprising a plurality of individual fibres, each comprising a large number of carbon nanotubes.

A typical fibre diameter is about 10 μm. The fibre diameter may be at least about 1 μm. The fibre diameter may be 1 mm or less, 100 μm or less, or 50 μm or less. Where it is electrically conductive, such a fibre, yarn or rope is useful as a current carrying component, for example in wiring applications.

Alternatively, the carbon material comprising carbon nanotubes may be a film. The film may have a thickness of at least 10 nm, for example at least 20 nm, at least 30 nm or at least 40 nm. The film may have a thickness of 1 mm or less, more preferably 500 μm or less, 250 μm or less, 100 μm or less, 1 μm or less, or 100 nm or less. A typical thickness is 50 nm. It will be understood that two or more films may be placed on top of each other e.g. to provide a plurality of overlying layers, which may together have a thickness greater than those set out above.

The carbon material comprising carbon nanotubes preferably has at least one dimension greater than 0.5 m. For example, it may have at least one dimension greater than 1 m, 2 m, 5 m, 10 m, 15 m or 20 m. Said at least on dimension may be the length of the fibre, yarn or rope.

Methods for continuous production of carbon materials comprising carbon nanotubes, e.g. fibres, are described in WO2008/132467, which is hereby incorporated by reference in its entirety and for all purposes, and in particular for describing methods for continuous production of carbon materials comprising carbon nanotubes.

The alloys of the present invention are particularly suitable for providing electrically conductive connections to and/or between carbon materials. Accordingly, it will be understood that preferably the carbon material is electrically conductive. For example, it may have a conductivity of at least 10⁴ S m⁻¹ in at least one direction (at room temperature). More preferably, it has a conductivity of at least 10⁵ S m⁻¹, or at least 0.7, 0.8, 0.9, 1.0, 1.1, 1.2, 1.3, 1.4, 1.5, 1.6, 1.7, 1.8, 1.9, or 2.0×10⁶ S m⁻¹ in at least one direction (at room temperature). It may have a conductivity as high as 10⁷ S m⁻¹ or more in at least one direction (at room temperature).

Where the carbon material comprises carbon nanotubes, it is preferred that the carbon nanotubes dominate the electrical properties of the material, thus providing the material with its electrical conductivity. Suitable methods for manufacturing conductive carbon nanotube materials are described in Reference 17 and in WO 2012/059716, which are hereby incorporated by reference in their entirety and for all purposes, and in particular for the purpose of describing the synthesis of conductive carbon materials comprising carbon nanotubes. Preferential growth of carbon nanotubes with metallic conductivity is also described in Reference 18, which is hereby incorporated by reference in its entirety and for all purposes, and in particular for the purpose of describing the synthesis of carbon nanotubes with metallic conductivity.

The carbon material may allow a current density of at least 15 A mm⁻², more preferably at least 20, at least 25, at least 30, at least 35, at least 40, at least 50, at least 60 or at least 70 A mm⁻². As used herein, the term “current density” refers to the current density which can be carried by the carbon material without requiring forced cooling to avoid runaway heating.

Preferably, the tin-based alloy comprises at least 10 wt % tin, preferably at least 20 wt %, at least 30 wt %, at least 40 wt %, at least 50 wt %, at least 60 wt %, at least 70 wt %, at least 80 wt %, or at least 90 wt % tin. In some preferred embodiments, the amount of tin is in the range 80-90 wt % tin.

Preferably, the matrix components are selected from two or more of Ag, Cu, Sb, Bi, Pb. The inventors consider that, amongst the candidate matrix components, Ag, Cu, Sb, Bi and Pb provide the most suitable matrix (with Sn) in which the active component(s) can provide their technical benefit to control of the wettability of the carbon material and the work of adhesion.

Where the alloy includes Ag, preferably it includes up to 5 wt % or up to 4 wt % Ag. The alloy may include at least 0.1 wt %, at least 0.2 wt %, at least 0.4 wt %, at least 0.5 wt %, at least 1 wt % or at least 2 wt % Ag.

Where the alloy includes Cu, preferably it includes up to 5 wt %, up to 4 wt %, up to 3 wt % or up to 2 wt % Cu. The alloy may include at least 0.1 wt %, at least 0.2 wt %, at least 0.3 wt %, at least 0.4 wt %, or at least 0.5 wt % Cu.

Where the alloy includes Sb, preferably it includes up to 5 wt %, up to 4 wt %, up to 3 wt % or up to 2 wt % Sb. The alloy may include at least 0.1 wt %, at least 0.2 wt %, at least 0.3 wt %, at least 0.4 wt %, or at least 0.5 wt % Sb.

Where the alloy includes Bi, preferably it includes up to 5 wt % or up to 4 wt % Bi. The alloy may include at least 0.1 wt %, at least 0.2 wt %, at least 0.4 wt %, at least 0.5 wt %, at least 1 wt % or at least 2 wt % Bi.

Where the alloy contains Sb, in some embodiments it is possible that the alloy contains essentially no Bi. In alternative embodiments, the alloy may contain both Sb and Bi.

Where the alloy includes Pb, preferably it includes up to 40 wt % Pb. In some cases it is possible to include up to 50 wt % Pb.

Preferably the transition metal active component is selected from one or more of Cr and Ni. The inventors consider that these transition metal active components provide the most suitable efficacy.

Preferably, the tin-based alloy contains a total amount of all said transition metal active components of 9 wt % or less, more preferably 8 wt % or less, more preferably 7 wt % or less, more preferably 6 wt % or less.

As has already been specified, the minimum amount of all said transition metal active components is more than 1 wt %. Where lower levels of said transition metal active components are provided, there is insufficient wetting of the carbon material.

Typically, the more of said transition metal active components included in the alloy, the higher the melting point of the alloy. Above 10%, the melting point can by too high for useful application of the alloy in the low temperature soldering processes described herein. Additionally, high levels of said transition metal active components included in the alloy can lead to breakdown of the carbon material. This is particularly relevant for carbon nanotube materials. A high content of transition metal active components included in the alloy tends to increase the range between the solidus temperature (the temperature below which the material is fully solid) and the liquidus temperature (the temperature above which the material is fully liquid). This range of temperatures for a particular solder alloy is sometimes referred to as the “pasty range”. A wide pasty range and a high content of solid phase at the soldering temperature can make the solder alloy difficult to handle.

Amongst the incidental impurities, oxygen may be included. Without wishing to be bound by theory, the present inventors believe that this is because the active components typically have a high affinity for oxygen, and readily react to form oxides. Oxygen may be present at levels up to 7 wt %, more preferably up to 5 wt %, up to 4 wt %, up to 3 wt %, up to 2 wt %, or up to 1 wt %.

Preferably, the incidental impurities includes a total of up to 5 wt % of impurities, more preferably a total of 4 wt % or less, 3 wt % or less, 2 wt % or less, or 1 wt %, or 0.5 wt % or less of impurities. Most preferably, the incidental impurities includes a total of up to 0.01 wt % of impurities. Of the total impurities, there is preferably no more than 1 wt % or 0.5 wt % of any individual impurity (with the optional exception of oxygen mentioned above), more preferably with no more than 0.4 wt %, 0.3 wt %, 0.2 wt %, or 0.1 wt %, or 0.01 wt % or, more preferably 0.0001 wt %, of any individual impurity.

Table 1 below sets out preferred upper limits for particular impurities which may be present in the alloys of the invention. The upper limit specified for each impurity is preferable independently, or in combination with upper limits for one or more other impurities.

TABLE 1

| Impurity | Preferred upper limit (wt %) |
|---|---|
| As | 0.01 |
| Pd | 0.01 |
| Mo | 0.01 |
| V | 0.01 |
| Se | 0.01 |
| N | 0.01 |
| H | 0.01 |
| C | 0.01 |
| O | 0.01 |
| S | 0.01 |

The upper limit for one or more of the listed impurities may be even lower, e.g. 0.001 wt % or 0.0001 wt %.

The incidental impurities may also include, for example, trace levels of other elements such as other metallic elements.

In the solder composition, the flux may be included at a level of up to 7 wt %, more preferably up to 5 wt %, up to 4 wt %, up to 3 wt %, up to 2 wt %, or up to 1 wt %.

Preferably, the tin-based alloy has a solidus temperature of 600° C. or below. More preferably, the solidus temperature may be 550° C. or below, 500° C. or below, 450° C. or below, 400° C. or below, 350° C. or below or 300° C. or below. It is possible for the solidus temperature to correspond to the melting temperature of tin (232° C.), or to be even lower with suitable concentrations of In, Bi or Pb for example. Accordingly, the tin-based alloy may have a solidus temperature of 232° C. or lower.

Preferably the tin-based alloys described herein are electrically conductive. For example, they may have an electrical conductivity within one or more of the ranges as described herein with reference to the carbon material.

As discussed above, the present invention provides a soldered product comprising a first component adhered to a second component via a solder material. The first component comprises a carbon material, as described herein. Accordingly, the first component may be, for example, a graphite or graphene component, a carbon fibre or a carbon material comprising carbon nanotubes, such as a carbon nanotube fibre or yarn.

Preferably, the first component is a current carrying component. For example, it may be in the form of an electrical cable, an electrical interconnect, an electrode, or an electrical wire. It may be a graphite panel or tile, useful for example in fusion reactors.

The nature of the second component is not particularly limited in the present invention. Preferably, it is electrically conductive, and accordingly it may be a current carrying component. For example, it may be in the form of an electrical cable, an electrical interconnect, an electrode, or an electrical wire. Similarly to the first component, it may comprise a carbon material, in which case the preferred and/or optional features of the first component described herein are equally applicable to the second component. Alternatively, the second component may be a different conductive component, such as a metal component.

It will be understood that the soldering process provides an electrically conductive connection to the first component, e.g. to the carbon material of the first component. Preferably, there is an electrically conductive connection between the first and second components, via the solder material.

The solder material comprises tin-based alloy filler, discussed in detail above, which is adhered at least to the carbon material of the first component. The first and second components may be connected directly via the tin-based alloy solder material, in which case the tin-based alloy filler is also adhered to the second component. Alternatively, the tin-based alloy filler may be indirectly adhered to the second component, via a further material such as a further filler material. This arrangement may be preferred in some embodiments, since in some preferable embodiments of the methods of the present invention, the tin-based alloy filler of the present invention is used in combination with a further filler material, such as a tin/lead alloy filler, as explained below.

Of course, the soldered products of the present invention may comprise further components, for example further components similar to the first and/or second components described herein. The further components may be connected, for example electrically connected, to each other and/or to the first and/or second components.

Preferably, the soldered product of the present invention is an electrical or electronic product, useful in a range of electrical and electronic applications. The electrical or electronic product may be useful, for example, in power transmission applications, in lightning protection systems, in data transmission wiring applications or in general electrical wiring applications.

It will be understood that the soldered product may comprise electrical circuitry. In that case, the first, second and further components may form part of the electrical circuit. In a preferred embodiment, the first component is a carbon nanotube fibre or yarn, and may be used as the current-carrying windings of an electromagnet, for example in a solenoid or more preferably in an electric motor or electric generator. The combination of properties of the carbon nanotube fibres or wires described herein are particularly well suited to the manufacture of small size and/or low weight electric motors.

As discussed above, the present invention provides a method of soldering a carbon material, wherein the tin-based alloy of the present invention is used as a filler. The tin-based alloy filler is melted, by heating it to a suitable temperature (e.g. not more than 700° C.), and then solidified in contact with the carbon material. In this way, the tin-based alloy filler is adhered to the carbon material. The tin-based alloy may be used to adhere a first component comprising carbon material to a second component, as described above with reference to the soldered product.

Preferably, the tin-based alloy filler is heated to a temperature of not more than 650° C., more preferably not more than 600° C., not more than 550° C., not more than 500° C., not more than 450° C., not more than 400° C., or not more than 350° C. Where lead is present, the temperature should preferably not exceed 500° C. for safety reasons, to avoid the production of harmful metal vapours.

The tin-based alloy filler may be heated to a temperature of at least 200° C., such as at least 210° C., at least 220° C., at least 230° C., at least 240° C., at least 250° C., at least 260° C., at least 270° C., at least 280° C., at least 290° C., or at least 300° C.

The present inventors have found that under some circumstances, the molten tin alloy filler may not spread readily on the substrate on which it is held. Without wishing to be bound by theory, this is believed to occur because the active component(s) in the alloy may have a strong tendency to be oxidised. This may lead to a stable metal oxide layer forming on the surface of the tin-based alloy filler, inhibiting its spreading to a certain extent. However, this oxide layer does not prevent adhesion of the tin alloy to carbon materials. Accordingly, even where this oxide layer is formed, the method is acceptable for some applications.

However, the formation of the oxide layer may make the tin-based alloy filler material more difficult to handle, and may reduce the joint strength between the carbon material and the tin-based alloy filler. Accordingly, in some cases it may be desirable to take steps to improve spreading of the tin-based alloy. For example, the soldering method (at least, e.g. the steps of heating and solidifying the alloy) may be carried out in a low oxygen environment, for example in an inert atmosphere, in a reducing atmosphere or in a vacuum.

In some embodiments, the soldering method (at least, e.g. the steps of heating and solidifying the alloy) may be carried out in air. The present inventors have also found that the problem of inhibited spreading of the tin-based alloy filler can be reduced or avoided without needing a low oxygen environment. The present inventors have found that by melting the tin-based alloy filler in contact with the melt of a further filler material, satisfactory spreading of the tin-based alloy filler is achieved.

Accordingly, the soldering method of the present invention may comprise melting a further filler material to provide further filler melt, the further filler material having a liquidus temperature which is lower than the liquidus temperature of the tin-based alloy filler, wherein during the step of heating the tin-based alloy filler to melt it, the tin alloy filler is in contact with the further filler melt. For example, the tin alloy filler may be submerged under the further filler melt.

To explain this point in more detail, it is possible for the solidus temperature to be substantially the same for each alloy. This is typically the case, for example, if the further filler and the tin-based alloy filler have the same or similar alloy matrix. Therefore both alloys start to melt at the same temperature (solidus temperature) but they are fully melted at different temperatures (liquidus temperatures). For example the typical further filler may have a melting range of 220-240° C. while the tin-based alloy filler may have a melting range of 220-500° C. That means at 240° C. partly molten tin alloy filler may be submerged under the fully molten further filler melt.

The present inventors have found that a further advantage of this process is that it can reduce the oxide content and porosity of the solidified tin-based alloy filler, further enhancing joint strength in the soldered product.

Without wishing to be bound by theory, the present inventors believe that oxidation and porosity tends to occur at least in part due to the higher melting point and larger pasty range of the tin-based alloys of the present invention which include the active component. For example, a Sn-5 wt % Ti alloy (although not containing the matrix components required by the present invention) is characterized by melting starting at 232° C. (solidus temperature) and a liquidus temperature of more than 450° C., where a Sn-40 wt % Pb alloy, which does not include active component has a pasty range of only 7° C.

It will be understood that the nature of the further filler material is not particularly limited in the present invention. The further filler material has a liquidus temperature lower than the liquidus temperature of the tin-based alloy filler. For example, it may be at least 10° C. lower, or at least 20° C. lower, or at least 30° C. lower, or at least 40° C. lower than the liquidus temperature of the tin-based alloy filler.

The further filler material is preferably an alloy. It may be combined in a solder composition with a flux, such as rosin flux. It may be preferable that the further filler material is eutectic, or near eutectic. It may be preferable that the liquidus temperature of the further filler material is lower than the solidus temperature of the tin-based alloy filler. For example, it may be at least 10° C. lower, or at least 20° C. lower, or at least 30° C. lower, or at least 40° C. lower than the solidus temperature of the tin alloy filler.

For example the further filler material may be a tin-lead alloy, such as an alloy comprising about 60 wt % tin and about 40 wt % lead. Other suitable further filler materials include tin-silver alloys (e.g. 96 wt % Sn+4 wt % Ag), tin-bismuth alloys (e.g. 43 wt % Sn+57 wt % Bi) tin-copper alloys (e.g. 99.7 wt % Sn+0.7 wt % Cu), tin-silver-copper alloys (e.g. Sn+3.6 wt % Ag+0.7 wt % Cu), tin-antimony alloys (e.g. Sn+5 wt % Sb).

In the soldering method, the carbon material may be soldered to a second component, as described herein e.g. with reference to the soldered product. Conveniently, where a further filler material is used, this filler material may adhere to the second component. For example, the further filler melt may be formed in contact with the second component, and may be solidified in contact with the second component and in contact with the tin-based alloy filler.

In this way, the carbon material (e.g. first component comprising carbon material) and the second component may be adhered to each other via solder material comprising both tin-based alloy filler material (which is typically adhered to the carbon material) and further filler material (which is typically adhered to the second component). In other words, the solder material may include both regions of the tin-based alloy filler material, and regions of the further filler material. Alternatively, of course, the solder material may comprise substantially only the tin-based alloy filler.

In some embodiments, the carbon material with tin-based alloy filler adhered thereon may be removed from the further filler melt, e.g. before solidification of the further filler melt. In this way, a first component comprising carbon material having a body (e.g. coating) of solder material formed thereon is produced. This first component may be adhered to a second component by heating the body of solder material and solidifying it in contact with the second component. For example, the second component may comprise carbon material having a body of solder formed thereon, and the first and second components may be adhered to each other by contacting the bodies of solder material and heating them. This approach is particularly useful for joining, for example, carbon fibres, carbon nanotube fibres, and/or carbon nanotube yarns.

### BRIEF DESCRIPTION OF THE DRAWINGS

Further preferred and or optional features of the invention, and preferred embodiments of the invention will now be described, with reference to the accompanying drawings in which:

FIG. 1 illustrates schematically the wetting behaviour of molten metals or molten metal alloys on carbon materials.

FIG. 2 illustrates schematically the wetting behaviour of a tin alloy of an embodiment of the present invention.

FIG. 3 illustrates schematically a soldering process according to an embodiment of the present invention.

FIG. 4 illustrates schematically a soldering process according to an embodiment of the present invention.

FIG. 5 shows a cross sectional SEM image of an interface between a carbon nanotube fibre and a tin-based alloy, for reference.

FIG. 6 shows results of EDX mapping for the cross section of FIG. 5.

FIGS. 7 and 8 show cross sectional optical micrographs of interfaces between a carbon nanotube fibre and a tin-based alloy according to an embodiment of the invention.

FIG. 9 is a graph showing mechanical properties of alloys according to embodiments of the invention in relation to Sn-3.6Ag-0.7Cu (properties measured after annealing of wires.

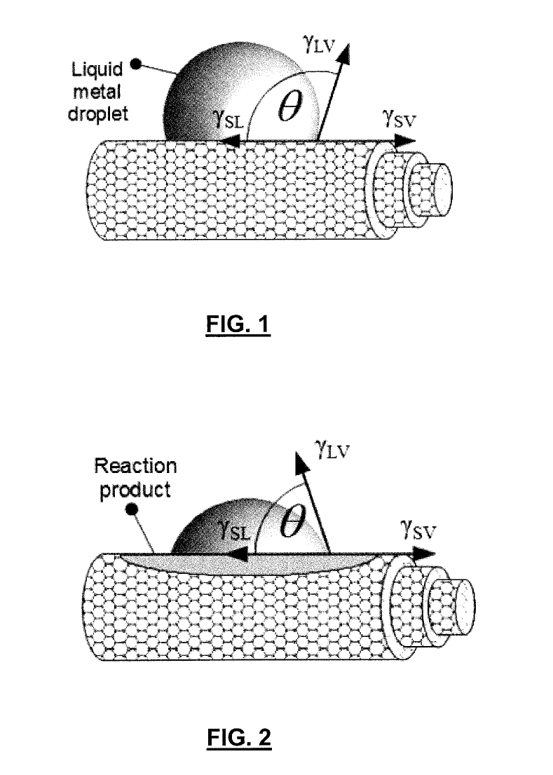

### DETAILED DESCRIPTION OF THE PREFERRED EMBODIMENTS, FURTHER OPTIONAL FEATURES OF THE INVENTION

It is often required that the structural materials employed in special applications of energy, aviation and automotive industries should be characterized, simultaneously, by low density, high melting temperature, good thermal conductivity, oxidation, corrosion and erosion resistivity as well as excellent mechanical properties in wide range of temperatures. The unique structure of graphite enables the fulfilment of most of these requirements. Therefore, both the classic and nanostructured carbon materials are expected to become the basis for many future applications. A key aspect enabling the use of the potential of carbon materials is the possibility of their joining with other materials including metals. The basic known methods of joining of carbon fibres as well as carbon fibre composites with other carbon materials or metals comprise: i) epoxy gluing, ii) mechanical joining and iii) brazing.

Epoxy adhesives employed both as the matrix of the composite materials as well as binder for joining them with other materials, including metals, are characterized by high hardness which entails increased brittleness and little capability of load transfer, particularly in case of vibrations. Epoxy is also an insulating material, eliminating it from consideration for thermal and electrical applications.

Mechanical joining with the use of screws or rivets causes stress concentration in the holes area, increases the total mass and impedes sealing/tightness of the construction.

Brazing requires the use of fluxes as well as high temperatures, usually >800° C., which implies the need of control of gaseous atmosphere. The high temperature used in the brazing process may lead to the combustion of carbon materials, in particular nanostructured ones. Such high temperatures also cause stress concentration during cooling of a joint between materials with considerable difference of thermal expansion coefficients. Relatively complex brazing procedures, often requiring the metallization of elements to be joined, extends the time and increases the cost of the operation.

Joining of carbon materials using low melt point temperature solders has not been possible until now due to lack of carbon wetting by commercially available solder alloys. In view of this, the present inventors have developed suitable new alloys as well as joining methods.

In this disclosure we present compositions, production methods and analysis of the properties of new (typically lead-free) soldering alloys which enable joining of carbon fibres, carbon nanotube fibres, as well as other carbon materials in both metal-carbon and carbon-carbon system. Soldering with the use of tin-based active alloys can now become an alternative joining method for the commonly used classic materials, e.g. carbon fibres, as well as increasing the range of potential applications of nanostructured carbon materials in particular in case of electrical systems.

Suitable example composition ranges of the tin-based alloy of the present invention are set out below.

Example composition range 1: Sn—Ag—Cu—Cr

Sn80 wt. %-97 wt. %

Ag 0.01 wt. %-6 wt. %

Cu 0.01 wt. %-3.5 wt. %

Cr 1 wt %-10 wt. %

plus impurities

Example composition range 2: Sn—Ag—Cu—Ni

Sn 80 wt. %-97 wt. %

Ag 0.01 wt. %-6 wt. %

Cu 0.01 wt. %-3.5 wt. %

Ni 1 wt %-10 wt. %

plus impurities

Example composition range 3: Sn—Ag—Bi—Cr

Sn 80 wt. %-97 wt. %

Ag 0.01 wt. %-6 wt. %

Bi 0.01 wt. %-5 wt. %

Cr 1 wt %-10 wt. %

plus impurities

Example composition range 4: Sn—Ag—Bi—Ni

Sn 80 wt. %-97 wt. %

Ag 0.01 wt. %-6 wt. %

Bi 0.01 wt. %-5 wt. %

Ni 1 wt %-10 wt. %

plus impurities

Example composition range 5: Sn—Ag—Cu—Sb—Cr

Sn 80 wt. %-97 wt. %

Ag 0.01 wt. %-6 wt. %

Cu 0.01 wt. %-3.5 wt. %

Sb 0.01 wt. %-0.5 wt. %

Cr 1 wt %-10 wt. %

plus impurities

Example composition range 6: Sn—Ag—Cu—Sb—Ni

Sn 80 wt. %-97 wt. %

Ag 0.01 wt. %-6 wt. %

Cu 0.01 wt. %-3.5 wt. %

Sb 0.01 wt. %-0.5 wt. %

Ni 1 wt %-10 wt. %

plus impurities

Example composition range 7: Sn—Ag—Bi—Cr—Ni

Sn 80 wt. %-97 wt. %

Ag 0.01 wt. %-6 wt. %

Bi 0.01 wt. %-5 wt. %

Cr 1 wt %-9 wt. %

Ni 1 wt %-9 wt. %

Cr+Ni<10 wt. %

plus impurities

Example composition range 8: Sn—Ag—Cu—Sb—Cr—Ni

Sn 80 wt. %-97 wt. %

Ag 0.01 wt. %-6 wt. %

Cu 0.01 wt. %-3.5 wt. %

Sb 0.01 wt. %-0.5 wt. %

Cr 1 wt %-9 wt. %

Ni 1 wt %-9 wt. %

Cr+Ni<10 wt. %

plus impurities

The ranges of composition for the tin-based alloy are summarised in Table 2, in which all figures are wt %.

TABLE 2
Alloy composition ranges

| | | | | | | | ACTIVE | |
|---|---|---|---|---|---|---|---|---|
| | MATRIX | | | | | | COMPONENT | |
| ALLOY | Sn | Ag | Cu | Sb | Bi | Imp. | Cr | Ni |
| SnAgCuCr | Bal. | 0.01-6.0 | 0.01-3.5 | — | — | <0.1 | >1.0-10.0 | — |
| | | | | | | each | | |
| SnAgCuNi | Bal. | 0.01-6.0 | 0.01-3.5 | — | — | <0.1 | — | >1.0-10.0 |
| | | | | | | each | | |
| SnAgBiCr | Bal. | 0.01-6.0 | — | — | 0.01-5.0 | <0.1 | >1.0-10.0 | — |
| | | | | | | each | | |
| SnAgBiNi | Bal. | 0.01-6.0 | — | — | 0.01-5.0 | <0.1 | — | >1.0-10.0 |
| | | | | | | each | | |
| SnAgBiCrNi | Bal. | 0.01-6.0 | — | — | 0.01-5.0 | <0.1 | 0-9.0* | 0-9.0* |
| | | | | | | each | | |
| SnAgCuSbCr | Bal. | 0.01-6.0 | 0.01-3.5 | 0.01-3.0 | — | <0.1 | >1.0-10.0 | — |
| | | | | | | each | | |
| SnAgCuSbNi | Bal. | 0.01-6.0 | 0.01-3.5 | 0.01-3.0 | — | <0.1 | — | >1.0-10.0 |
| | | | | | | each | | |
| SnAgCuSbCrNi | Bal. | 0.01-6.0 | 0.01-3.5 | 0.01-3.0 | — | <0.1 | 0-9.0* | 0-9.0* |
| | | | | | | each | | |

*provided that 1 wt % < Cr + Ni ≦10 wt %

Specific alloys manufactured in the course of the present work are detailed in Table 3, in which all figures are wt %.

TABLE 3
Specific tin-based alloy compositions

| | | | | | | ACTIVE | |
|---|---|---|---|---|---|---|---|
| | MATRIX | | | | | ELEMENT | |
| ALLOY | Sn | Ag | Cu | Sb | Bi | Cr | Ni |
| SnAgCuCr | BAL. | 3.6 | 0.7 | — | — | 2.5 | — |
| | BAL. | 3.6 | 0.7 | — | — | 5.0 | — |
| SnAgCuNi | BAL. | 3.6 | 0.7 | — | — | — | 2.5 |
| | BAL. | 3.6 | 0.7 | — | — | — | 5.0 |
| SnAgBiCr | BAL. | 4.0 | — | — | 3.0 | 5.0 | — |
| SnAgBiNi | BAL. | 4.0 | — | — | 3.0 | — | 5.0 |
| SnAgBiCrNi | BAL. | 4.0 | — | — | 3.0 | 2.5 | 2.5 |
| SnAgCuSbCr | BAL. | 3.6 | 0.7 | 1.0 | — | 5.0 | — |
| SnAgCuSbNi | BAL. | 3.6 | 0.7 | 1.0 | — | — | 5.0 |
| SnAgCuSbCrNi | BAL. | 3.6 | 0.7 | 1.0 | — | 2.5 | 2.5 |

Table 4 specifies the preferred matrix components to be used in the tin-based alloy, and sets out additional/alternative matrix components. The melting and boiling points for the different matrix components are given.

TABLE 4
Matrix components
MATRIX COMPONENT

| | PREFERED | | | | | | | | | | | | | | |
|---|---|---|---|---|---|---|---|---|---|---|---|---|---|---|---|
| | COMPONENT | | | | | ADDITIONAL/ALTERNATIVE COMPONENT | | | | | | | | | |
| | Sn | Ag | Cu | Sb | Bi | Pb | In | Zn | Cd | Ga | Au | Ge | Si | P | Al |
| Melting | 232 | 961 | 1084 | 431 | 271 | 327 | 157 | 420 | 321 | 30 | 1065 | 937 | 1410 | 44 | 660 |
| point [° C.] | | | | | | | | | | | | | | | |
| Boiling | 2270 | 2163 | 2567 | 1587 | 1564 | 1740 | 2073 | 907 | 765 | 2403 | 2087 | 2830 | 2355 | 280 | 2467 |
| point [° C.] | | | | | | | | | | | | | | | |

Table 5 specifies the preferred active components to be used in the tin-based alloy, and sets out additional/alternative active components. The melting and boiling points for the different active components are given.

TABLE 5
Active components
ACTIVE COMPONENT

| | PREFERED | | | | | | | | | | |
|---|---|---|---|---|---|---|---|---|---|---|---|
| | COMPONENT | | ADDITIONAL/ALTERNATIVE COMPONENT | | | | | | | | |
| ELEMENT | Cr | Ni | Ti | Co | Fe | Mn | Nb | Mo | Hf | Ta | W |
| Melting | 1857 | 1453 | 1660 | 1495 | 1535 | 1244 | 2468 | 2617 | 2227 | 2996 | 3407 |
| point [° C.] | | | | | | | | | | | |
| Boiling | 2672 | 2732 | 3287 | 2870 | 2750 | 1962 | 4742 | 4612 | 4603 | 5425 | 5655 |
| point [° C.] | | | | | | | | | | | |

The interaction of liquid metals with carbon materials, both classic and nanostructured ones, involves several processes often difficult to describe. These include for example adsorption of active element on the interphase boundary as well as diffusion of the components through the interphase boundary with simultaneous nucleation and growth of new phase.

This interaction is defined by the phase equilibria diagrams, based on which it is possible to determine the ability of the component to form the terminal solid solutions, the terminal solubility of components, the type of intermetallic phases as well as their stoichiometric composition. The determination of the wetting mechanism in the metal-carbon system, in which intermediate phases are formed, requires an understanding of the cause and method of their formation as well as their composition and structure, particularly in the initial stage of the process. The wettability of carbon requires that the chemical compounds formed on the phase boundaries should have a metal-like nature, be soluble in liquid metal or constitute easily removable gases. Both the mechanism and the temperature of formation of new phases which are the condition of the wetting of carbon materials do not always corresponds to the phase equilibria diagrams. The structure and the speed of their formation depend on both the kinetic and thermodynamic factors. In non-equilibrium systems the contact angle, and therefore the work of adhesion, depend significantly on the temperature, which is reflected in the soldering processes.

The physicochemical factors enabling the control of the wetting in the metal-carbon system include: i) the chemical activity of alloy components with regards to solid phase (Gibbs free energy ΔG of the formation of solid phase), ii) critical value of the molar fraction of active element, that produces a sharp wetting transition (which depends on its activity), iii) the terminal solubility of solid phase in liquid metal as well as type of the formed products, iv) the phenomena resulting from the state of the surface of the solid phase (porosity, roughness, chemical inhomogeneity) and its orientation (crystallographic structure).

The addition of one, two or several active components, chosen from the transition metal group, to a non-reactive matrix (e.g. Cu, Ag, Sn, Au, Ge, Ga or their alloys) is proposed by the inventors as constituting an effective method of the improvement of the wettability in the metal-carbon system, on condition that the transition metal should be highly active in a given matrix.

The correlation of adhesion and thermodynamic activity of alloy components is manifested in the adsorption of active ingredients on the phase boundary. In case of low activity the components of the alloy become segregated close to the phase boundary line, whereas in case of high activity the formation of intermediate phases is observed. The work of adhesion between the liquid and solid phase may be also achieved in the systems of high solubility of carbon, upon simultaneous lack of formation of stable carbides. Obtaining a strong bond between metals and non-metals requires the proper choice of the composition of the soldering alloy. Via changing the type and concentration of active additives, as well as type of non-active base (matrix), it is possible to control the course of the surface processes and thus influence the wetting angle and work of adhesion.

Assuming that wetting of a reactive nature is the main mechanism conditioning the effectiveness of the soldering material, an alloy group Sn—X—Y (where X is one or more active component chosen from the transition metals group and Y corresponds to non-active additives shaping other solder functional properties), was designed and smelted. The soldering of carbon fibres and carbon nanotube fibres was performed in air, with the use of classic soldering station and temperatures in the range from 300° C. to 450° C.

In a preliminary analysis, these solders showed a high tendency of oxidation of tin-based active alloys. Therefore, fluxes and other procedures enabling the improvement of the solder spreadability were used. Fluxes were assessed based on the ability of the solder to spread and adhere to a Cu substrate. The methods used in this work included one-step soldering using fluxes of various activity and two-step soldering procedures taking into account the formation of buffer layer in the form of non-active soldering with the aid of rosin.

The usefulness of the methods was analysed based on a visual assessment of the wettability of the base material, wettability of the fibre as well as the joint appearance. The use of active fluxes was seen to constitute the most effective method of the improvement of the Sn—X—Y alloys' spreadability but prevents the wetting of the carbon/carbon nanotube fibres, simultaneously. The reduction of the activity of solder components with regard to carbon can be explained by the unfavourable course of the reaction of the flux with solder. Fluxes of low and medium activity allow the wetting of the fibres but cannot improve the spreadability of the solder. Better results were obtained in case of two-stage soldering process that involved the formation of a buffer layer with the aid of a non-active lead or lead-free solder. The active alloy melted on the surface of the buffer layer which has lower melting temperature, underwent a transition into liquid state under the protective buffer layer and as a result did not become oxidized. Simultaneously, the non-active or low-activity flux present in the commercially available solder wires enables the activation of the base and improves the spreadability of molten mixture of further filler material—tin-based alloy.

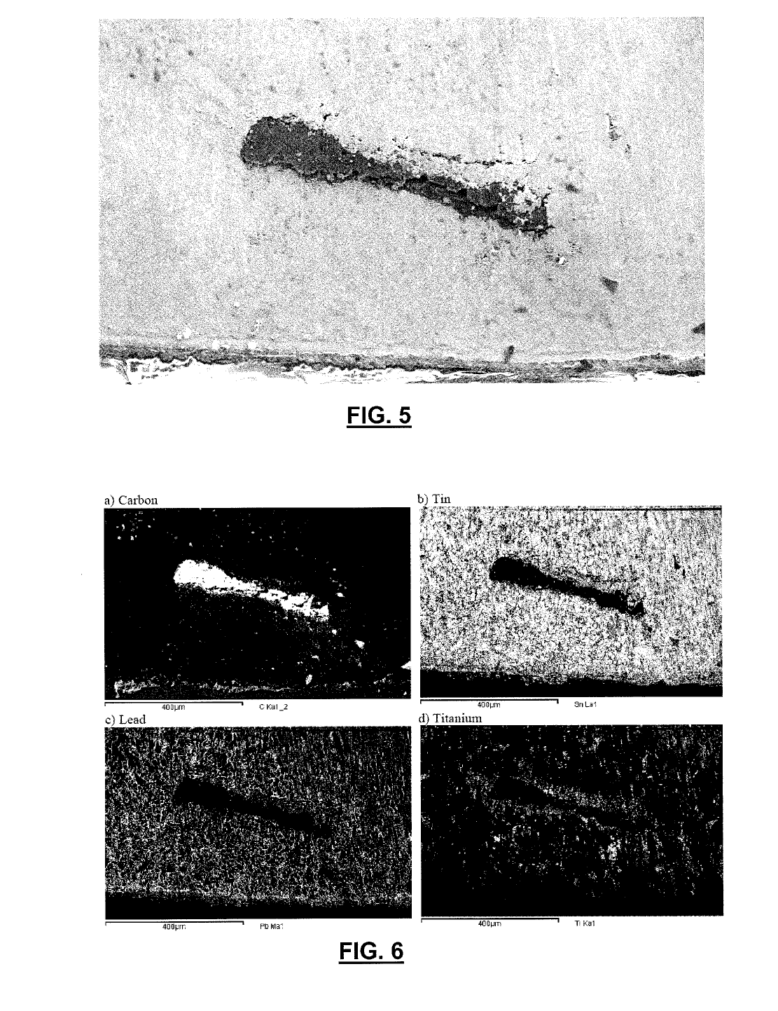

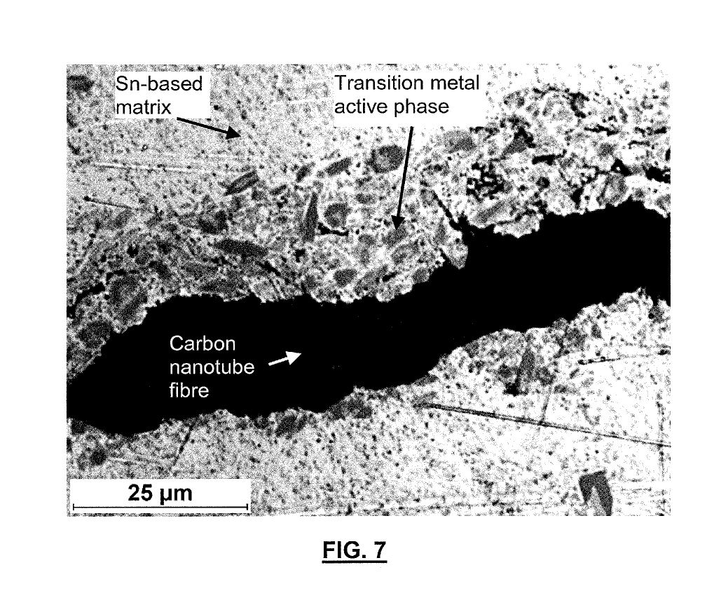

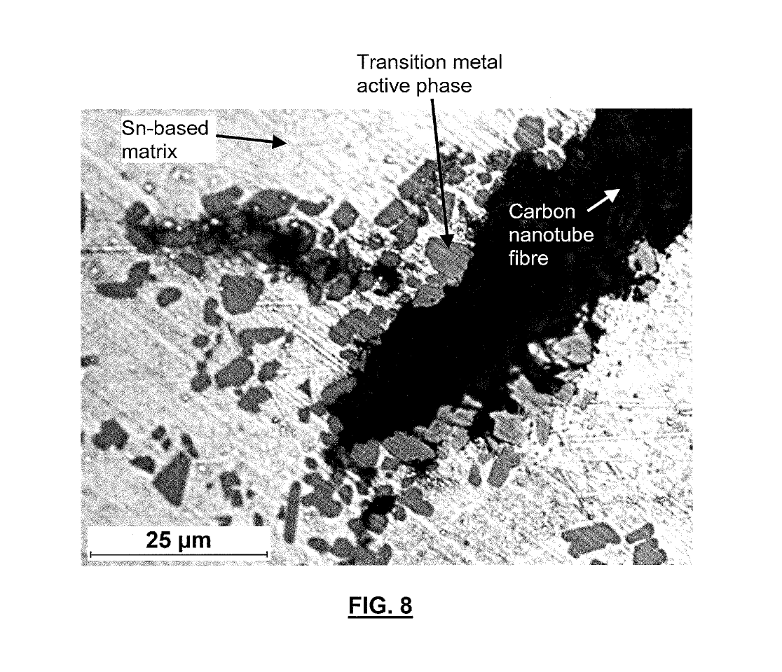

Microscopic analysis and EDX mapping of joints prepared during soldering with alloys according to embodiments of the invention without the use of fluxes or via the two-stage procedure show a homogenous distribution of Sn and other non-active components of the solder in the cross-section of the soldered joint. A considerable concentration of active component around carbon or carbon nanotube fibres can be observed, simultaneously. The results are shown in FIGS. 5, 6, 7 and 8. The substantial contribution of active transition metal-rich phases around fibres indicates their activity with regard to carbon even in very low temperature. It is noted here that the alloy composition shown in FIGS. 5 and 6 is Sn—Pb—Ti and is outside the scope of the present invention, yet still serves to indicate the distribution of active transition metal component Ti in relation to the solder and the carbon material.

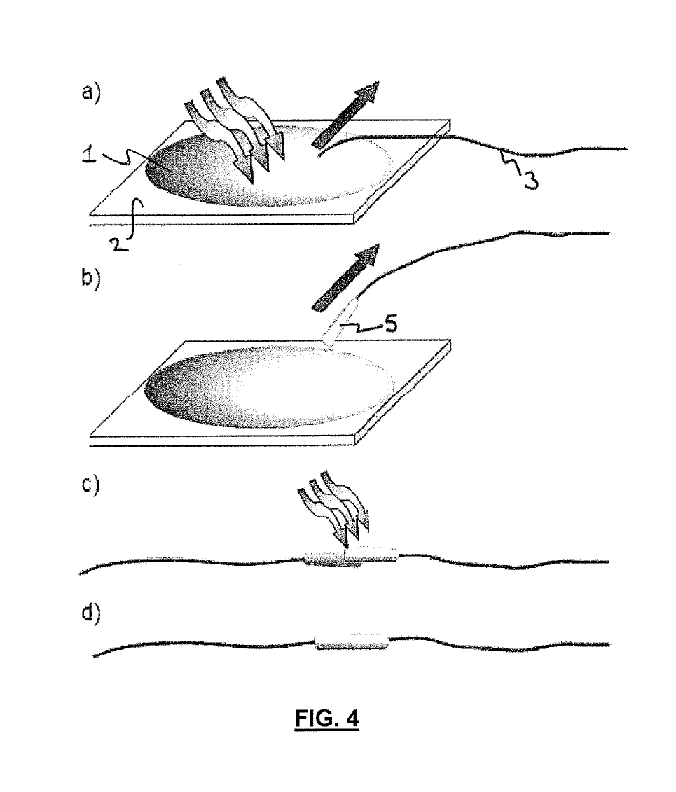

Based on the procedure of soldering of carbon/carbon nanotube fibres to the Cu base, the method of overlap joining of individual carbon/carbon nanotube fibres as well as their bundles was developed. The soldering of classic and nanostructured carbon materials in the carbon-carbon system was performed with the use of two-stage procedure, which involves the formation of metallic coatings on the surfaces to be joined and subsequently their spot heating allowing the metallurgical joining (FIG. 4). A series of joints of individual carbon nanotube fibres with a similar linear density i.e. from 0.4 to 0.8 [tex] ([g/km]) was made using alloys according to embodiments of the invention. The individual carbon nanotube fibres as well as their joints were subject to static tensile test in Favimat machine (Tex Techno Instruments). The gauge length was set at 40 mm and the testing speed at 10%/min. All of the analysed samples fractured beyond the solder area, at an average tensile strength of 0.8 N/tex. The lack of pull out of the fibre from the alloy demonstrates the high quality of the phase boundary in the carbon nanotube fibre—tin-based alloy system. The testing of the strength of overlap joints provided for a bunch of 12000 HexTow® IM10 carbon fibres were performed with the use of Hounsfield 5kN tester. The gauge length was set at 50 mm and a testing speed of 10%/min was used. The measurements performed on joints with a constant length of the overlap of 10 mm had a shear strength in the range from 0.1-0.4 MPa.

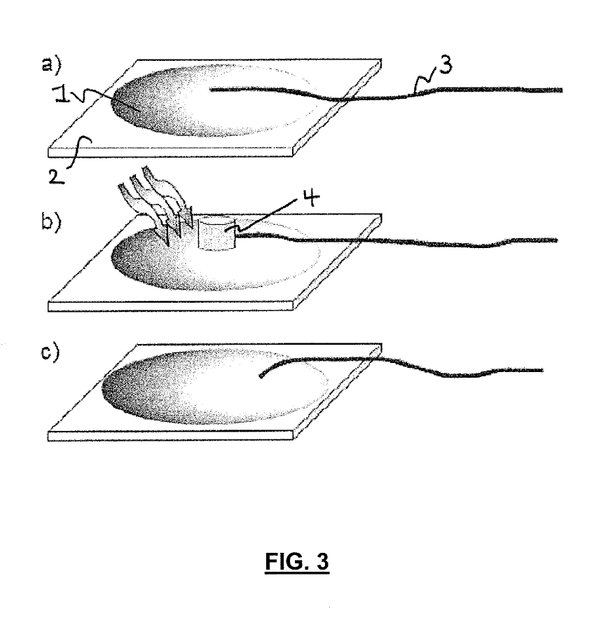

We now describe the two-stage soldering procedure in more detail. The process is illustrated schematically in FIG. 3. As illustrated in part (a) of FIG. 3, a further filler material 1 is melted to provide further filler material melt, on a copper substrate 2. For example, commercially available Sn-40 wt % Pb with rosin-based flux may be used. This alloy has a melting point of about 190° C., and the optimum temperature for soldering is in the range form 270° C. to 500° C. The carbon material 3, which may be, for example, a fibre or yarn comprising carbon nanotubes, or a carbon fibre, is not wetted by the further filler melt.

As illustrated in part (b) of FIG. 3, tin-based alloy filler 4 according to an embodiment of the present invention is placed in contact with the further filler melt 1, and in contact with the carbon material 3. The molten further filler material 1 wets the solid tin-based alloy filler 4. The tin-based alloy filler 4 is then melted. The optimum temperature for this is about 350° C.-450° C. After reaching the solidus temperature of the tin-based alloy filler material, its transition into the liquid state follows under a protective layer of the further filler material. Despite the large range of crystallization and the strong affinity of the tin-based alloy filler to oxygen, the further filler material layer protects the tin-based alloy filler from oxidation and allows active solder to wet fibres as illustrated in part (c) of FIG. 3.

A variant of this preferred embodiment of the soldering process is illustrated in FIG. 4. After the stage illustrated in FIG. 3 part (c), the carbon material is withdrawn from the further filler material. A coating 5 of the tin-based alloy filler material remains adhered to the carbon material, as illustrated in part (b) of FIG. 4. If necessary, the coating procedure can be repeated to build up layers of tin-based alloy filler formed on the carbon material.

Two pieces of carbon material can then be soldered together, e.g. by spot heating, as illustrated in part (c) of FIG. 4, by heating the tin-based alloy filler coating formed on the pieces of carbon material. The heating should be to a temperature slightly exceeding the melting point of tin (which is approximately 232° C.).

The electrical and mechanical properties of solder compositions according to the present invention were compared with those of conventional Sn—Ag—Cu solder.

Due to small resistance of 1 mm Sn—X wires, resistivity was measured using the well-known two point and four point methods. The results are shown in Tables 6 and 7. In the two point method a proper value is indicated by the voltmeter while the ammeter indicates a value increased by the current flowing through the voltmeter. The relative measurement error (Equation 1) is negligibly small (2×10⁻⁹%) because of the high voltmeter input resistance (Rv=10 MΩ) and the small measured resistance of the sample (the order of microohms). The wire resistance may be calculated from Equation 2 while alloy may be calculated from Equation 3.

$$\begin{matrix}δ = - \frac{R}{R + {R}_{V}} 100 \% & ( Equation 1 ) \\ R = \frac{U}{I} [ Ω ] & ( Equation 2 ) \\ R = ρ \frac{L}{S} ⇒ ρ = R \frac{S}{L} [ Ω m ] & ( Equation 3 )\end{matrix}$$

where:

S=wire cross section area

L=measured wire length

U=measured voltage

I=measured current

R=calculated resistance

δ=relative measurement error

The four point method allows the elimination of the resistance of connecting the leads to the sample by separating the voltage and current contacts. The resistance indicated by the instrument is calculated as a voltage measured by voltmeter per known value of current generated by the internal power source. In the present work, the four point method was used for the resistance measurement of 1 mm diameter wire while the two point method was more relevant for measurement of 3 mm diameter wire (typically having 10 times smaller resistance). Additional measurements were carried out for typical commercially available lead free solder Sn-3.6Ag-0.7Cu

TABLE 6
wire resistance and alloy resistivity measured using two point method

| | I | U | R | L | d | S | Resistivity |
|---|---|---|---|---|---|---|---|
| Alloy | [mA] | [mV] | [Ω] | [cm] | [cm] | [cm²] | (μΩ · cm) |
| Sn—3.6Ag—0.7Cu—2.5Cr | 100.0 | 18.03 | 0.1803 | 140.0 | 0.1 | 0.007853975 | 10.11 |
| Sn—3.6Ag—0.7Cu—5.0Cr | | 19.27 | 0.1927 | | | | 10.81 |
| Sn—3.6Ag—0.7Cu—2.5Ni | | 19.46 | 0.1946 | | | | 10.92 |
| Sn—3.6Ag—0.7Cu—5.0Ni | | 19.58 | 0.1958 | | | | 10.98 |
| Sn—3.6Ag—0.7Cu | | 22.5 | 0.225 | | | | 12.62 |
| (reference) | | | | | | | |

TABLE 7
wire resistance and alloy resistivity measured using four point method

| | | | | | Resis- |
|---|---|---|---|---|---|
| | | | | | tivity |
| | L | d | S | R | (μΩ · |
| Alloy | [cm] | [cm] | [cm²] | [Ω] | cm) |
| Sn—3.6Ag—0.7Cu—2.5Cr | 140.0 | 0.1 | 0.007853975 | 0.186 | 10.43 |
| Sn—3.6Ag—0.7Cu—5.0Cr | | | | 0.188 | 10.55 |
| Sn—3.6Ag—0.7Cu—2.5Ni | | | | 0.198 | 11.11 |
| Sn—3.6Ag—0.7Cu—5.0Ni | | | | 0.197 | 11.05 |
| Sn—3.6Ag—0.7Cu | | | | 0.223 | 12.51 |
| (reference) | | | | | |

The alloys of the present invention therefore provide a 11-16% improvement in resistivity over the conventional Sn—Ag—Cu solder Sn-3.6Ag-0.7Cu.

The mechanical properties of the various solders was also assessed. Table 8 shows the results, including the results for a conventional Sn—Ag—Cu alloy.

Tensile tests were carried out using 1 mm diameter wires. In order to reduce stress induced during plastic deformation of material, some wires have been annealed for 1 hour in air at 190° C. Tensile tests were carried our for wires annealed in this way and for wires not annealed.

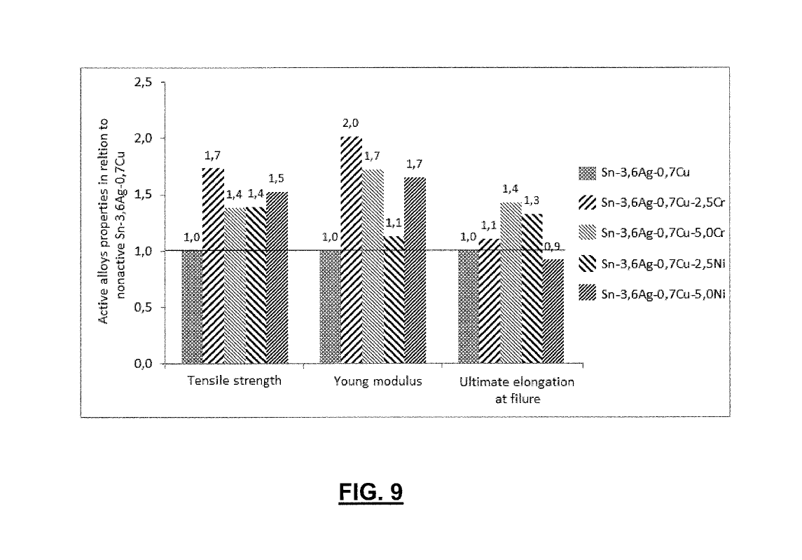

The tensile tests were carried our using a screw driven Hounsfield 5 kN tensile test machine. All tests were made with gauge length 90 mm and strain rate of 9 mm/s (10% of gauge length per minute). The results are shown in Table 8 and FIG. 9. In FIG. 9, the values shown are for wires tested after annealing.

TABLE 8
Tensile test results for active Sn—X and SnAgCu—X alloys
(average value based on 5 tests for each alloy)

| | | Tensile | | Young | | Ultimate | |
|---|---|---|---|---|---|---|---|
| | | strength | | modulus | | elongation | |
| Alloy | | [MPa] | | [GPa] | | [%] | |
| group | Alloy composition | No HT | HT | No HT | HT | No HT | HT |
| Sn—X | Sn—2.5Cr | 41.4 | 40.0 | 2.39 | 3.64 | 11.9 | 12.9 |
| | Sn—5.0Cr | 47.8 | 39.0 | 2.74 | 4.83 | 10.0 | 11.8 |
| | Sn—2.5Ti | 42.8 | 42.2 | 2.09 | 7.7 | 17.8 | 3.1 |
| | Sn—5.0Ti | 42.2 | 39.6 | 1.77 | 4.16 | 16.0 | 21.1 |
| | Sn—5.0Ni | 56.8 | 52.4 | 1.46 | 4.33 | 12.2 | 11.9 |
| SnAgCu—X | Sn—3.6Ag—0.7Cu—2.5Cr | 74.2 | 71.7 | 5.25 | 8.00 | 21.1 | 18.04 |
| | Sn—3.6Ag—0.7Cu—5.0Cr | 74.0 | 57.1 | 5.18 | 6.84 | 37.5 | 23.3 |
| | Sn—3.6Ag—0.7Cu—2.5Ni | 67.0 | 57.5 | 4.01 | 4.47 | 29.5 | 21.6 |
| | Sn—3.6Ag—0.7Cu—5.0Ni | 70.5 | 63.0 | 4.63 | 6.55 | 23.4 | 15.0 |
| | Sn—3.6Ag—0.7Cu | 64.8 | 41.3 | 3.63 | 3.96 | 6.3 | 16.3 |
| | (reference) | | | | | | |

HT—heat treatment (190° C., 1 h)

The inventors have found that flux is not necessarily required to solder carbon to copper or copper to copper. Soldering carbon to copper (and incidentally also soldering copper to copper) contacts are the most suitable implementation of the preferred embodiments of the invention.

Flux is found to worsen the wetting of carbon materials but is necessary to wet aluminium and steel. It is therefore typically found to be necessary, when soldering carbon to aluminium or carbon to steel, to use a 2-step soldering process. This 2-step soldering process for carbon-to-aluminium or carbon-to-steel can be carried out as follows. First a base layer is made using active or non-active solder and flux. Next, carbon material is soldered to the base layer using active solder without flux. The flux is needed contacting the aluminium or steel surface.

The suitable type of flux is selected depending on steel or aluminium alloy composition, based on normal technical considerations. Typical known fluxes for soldering steel and aluminium are suitable.

The use of flux for soldering carbon to copper is optional. An active alloy according to an embodiment of the invention with flux may replace further filler material in a two step soldering process. In this case it is possible to use wide range of fluxes (e.g. resin (based on pine sap) and/or active and corrosive acid based fluxes).

It is possible for the alloy to include a carbon material. This is found in particular to improve the wetting of stainless steel by the solder composition. Additional benefits include improving alloy thermal conductivity, improving alloy electrical conductivity, and improving alloy mechanical properties. The inventors developed compositions for SnAgCuCr and SnAgCuNi alloys. Substantially irrespective of the carbon material form, the alloy may comprise 0.01-1.0 wt % C. In practice, however, the carbon content is preferably not larger than 0.3 wt % because at C contents higher than this, the solderability of the alloy may be reduced due a high content of solid material (carbon) increasing significantly the viscosity.

The inventors have therefore devised a group of alloys and soldering procedures suitable for joining of carbon fibres or carbon nanotube based fibres to each other or to a copper base (or another base) that can be wetted by conventional commercially available soft solders. Existing high temperature processes are unsuitable for use with carbon materials which can be susceptible to thermal degradation, such as carbon nanotubes, since these materials may break down under the conditions employed. The procedures disclosed here constitute effective methods for joining of carbon based structures for electrical applications and mechanical performance because of the ability to use a conventional soldering iron as a heat source and there being no specific requirement for changing the atmosphere in which the soldering procedure is carried out.

The preferred embodiments have been described by way of example only. Modifications to these embodiments, further embodiments and modifications will be apparent to the skilled person and as such are within the scope of the present invention.

All references referred to above are hereby incorporated by reference.

### LIST OF NON-PATENT DOCUMENT REFERENCES

1. Noorden R.: The Trials of New Carbon, Nature, vol. 469, pp. 14-16, 2011
2. Patel-Predd P.: Carbon-nanotube wiring gets real, IEEE Spectr., vol. 45, no. 4, p. 14, 2008
3. Hikata T.: Development of New Carbon Nanotube Production Technique Carbon Transmission Method, SEI Technical Review, Number 66, pp. 81-84, 2008
4. Elcock, D.: Potential Impacts of Nanotechnology on Energy Transmission Applications and Needs, ANL/EVS/TM/08-3, prepared by Environmental Science Division, Argonne National Laboratory, 2007
5. Collins P.: Nanotubes for Electronics, Scientific American, pp. 62-69, 2000
6. Koziol K.: High-Performance Carbon Nanotube Fiber, Science, Vol. 318 no. 5858 pp. 1892-1895, 2007
7. Popov V.: Carbon nanotubes: properties and application, Materials Science and Engineering, R 43, pp. 61-102, 2004
8. Dresselhaus M.: Electronic, thermal and mechanical properties of carbon nanotubes, Phil. Trans. R. Soc. Lond. A 362, pp. 2065-2098, 2004
9. Bakshi S. at al.: Interface in carbon nanotube reinforced aluminium silicon composites: Thermodynamic analysis and experimental verification, Journal of Alloys and Compounds 481, pp. 207-213, 2009
10. Laha T. at al.: Interfacial phenomena in thermally sprayed multiwalled carbon nanotube reinforced aluminium nanocomposite, Acta Materialia 55, pp. 1059-1066, 2007
11. Esawi A., Farag M.: Carbon nanotube reinforced composites: Potential and current challenges, Materials and Design 28, pp. 2394-2401, 2007
12. Bakshi S. at al.: Carbon nanotube reinforced metal matrix composites—a review, International Materials Reviews, Vol. 55 No 1, pp. 41-64, 2010
13. Ebbesen T.: Wetting, filling and decorating carbon nanotubes, J. Phys. Chem Solids, Vol. 57, pp. 951-955, 1996
14. Jackowski J., at al.: Ocena w [symbol] aściwości powierzchniowych ciek [symbol] ych metali i stopów w ośrodkach ciek [symbol] ych. Kompozyty (Composites) 6, pp. 60-64, 2006
15. Chen, at al.: Preparation and properties of Cu matrix composite reinforced by carbon nanotubes. Trans. Nonferrous Met. Soc. China 15, pp.314-318, 2005
16. Kim Ch., at al.: Strengthening of copper matrix composites by nickel-coated single-walled carbon nanotube reinforcements, Synthetic Metals 159, pp. 424-429, 2009.
17. R. M. Sundaram, K. K. Koziol, A. H. Windle, Continuous Direct Spinning of Fibers of Single-Walled Carbon Nanotubes with Metallic Chirality, Advanced Materials, Vol. 23, Issue 43, pp. 5064-5068.
18. Preferential Growth of Single-Walled Carbon Nanotubes with Metallic Conductivity,

Avetik R. Harutyunyan, Gugang Chen, Tereza M. Paronyan, Elena M. Pigos, Oleg A. Kuznetsov, Kapila Hewaparakrama, Seung Min Kim, Dmitri Zakharov, Eric A. Stach, and Gamini U. Sumanasekera, Science, 2009, 326, 116-120
19. Y. W. Wang, Y. W. Lin, C. T. Tu, C. R. Kao, Effects of minor Fe, Co, and Ni additions on the reaction between SnAgCu solder and Cu Journal of Alloys and Compounds, Volume 478, Issues 1-2, 10 Jun. 2009, 121-127
20. C. L. Chuang, L. C. Tsao, H. K. Lin, L. P. Feng, Effects of small amount of active Ti element additions on microstructure and property of Sn3.5Ag0.5Cu solder, Materials Science and Engineering: A, Volume 558, 15 December 2012, Pages 478-484.

1. A tin-based alloy consisting essentially of:
matrix components comprising two or more of Ag, Cu, Sb, Bi, Pb, In, Zn, Cd, Ga, Au, Ge, Si, P, Al, each matrix component being present in an amount 0.01-6.0 wt %;
a transition metal active component comprising one or more of Cr, Ni, Ti, Co, Fe, Mn, Nb, Mo, Hf, Ta, W, the total amount of all said transition metal active components being more than 1.0 wt % and not more than 10 wt %;
optionally C present in an amount 0.01-1.0 wt %, and
a balance of Sn and incidental impurities.

2. The tin-based alloy according to claim 1 having a solidus temperature of 500° C. or lower.

3. The tin-based alloy according to claim 1 having a solidus temperature of 300° C. or lower.

4. The tin-based alloy according to claim 1 wherein the matrix components are selected from two or more of Ag, Cu, Sb, Bi, Pb.

5. The tin-based alloy according to claim 1 wherein the transition metal active component is selected from one or more of Cr and Ni.

6. The tin-based alloy according to claim 1 wherein the alloy contains at least 70 wt % Sn.

7. The tin-based alloy according to claim 1 wherein the alloy contains C present in an amount 0.01-1.0 wt %.

8. A solder composition comprising:
(i) a tin-based alloy consisting essentially of:
matrix components comprising two or more of Ag, Cu, Sb, Bi, Pb, In, Zn, Cd, Ga, Au, Ge, Si, P, Al, each matrix component being present in an amount 0.01-6.0 wt %;
a transition metal active component comprising one or more of Cr, Ni, Ti, Co, Fe, Mn, Nb, Mo, Hf, Ta, W, the total amount of all said transition metal active components being more than 1.0 wt % and not more than 10 wt %;
optionally C present in an amount 0.01-1.0 wt %, and
a balance of Sn and incidental impurities; and
(ii) flux.

9-13. (canceled)

14. A method of soldering a carbon material, the method comprising:
heating a tin-based alloy filler to melt it, the tin-based alloy consisting essentially of:
matrix components comprising two or more of Ag, Cu, Sb, Bi, Pb, In, Zn, Cd, Ga, Au, Ge, Si, P, Al, each matrix component being present in an amount 0.01-6.0 wt %;
a transition metal active component comprising one or more of Cr, Ni, Ti, Co, Fe, Mn, Nb, Mo, Hf, Ta, W, the total amount of all said transition metal active components being more than 1.0 wt % and not more than 10 wt %;
optionally C present in an amount 0.01-1.0 wt %, and
a balance of Sn and incidental impurities, and:
solidifying the tin-based alloy filler in contact with the carbon material.

15. The method according to claim 14 wherein the method further comprises melting a further filler material to provide further filler melt, the further filler material having a solidus temperature which is lower than the solidus temperature of the tin-based alloy filler, wherein during the step of heating the tin-based alloy filler to melt it, the tin-based alloy filler is in contact with the further filler melt.

16. The method according to claim 14 wherein the carbon material is graphite, graphene, carbon fibre or a material comprising carbon nanotubes.

17. The method according to claim 14 wherein the carbon material comprises at least 75 wt % of carbon nanotubes.

18. The method according to claim 14 wherein the carbon material comprising carbon nanotubes is in the form of a fibre or yarn.

19. The method according to claim 14 wherein the carbon material is electrically conductive.

20. A soldered product comprising a first component electrically conductively connected to a second component via solder material, wherein the first component comprises carbon material, which carbon material is adhered to the solder material and wherein the solder material comprises a tin-based alloy filler consisting essentially of:
matrix components comprising two or more of Ag, Cu, Sb, Bi, Pb, In, Zn, Cd, Ga, Au, Ge, Si, P, Al, each matrix component being present in an amount 0.01-6.0 wt %;
a transition metal active component comprising one or more of Cr, Ni, Ti, Co, Fe, Mn, Nb, Mo, Hf, Ta, W, the total amount of all said transition metal active components being more than 1.0 wt % and not more than 10 wt %;
optionally C present in an amount 0.01-1.0 wt %, and
a balance of Sn and incidental impurities.

21. The soldered product according to claim 20 wherein the first component is an electrically conductive fibre or yarn comprising at least 75 wt % of carbon nanotubes.

22. The soldered product according to claim 20 wherein the second component is made of metal, or is an electrically conductive fibre or yarn comprising at least 75 wt % of carbon nanotubes.
